(19) United States
(12) Patent Application Publication
(10) Pub. No.: US 2015/0228989 A1
(43) Pub. Date: Aug. 13, 2015

(54) METHOD FOR DETECTING A CRITICAL CONCENTRATION OF HYDROGEN

(71) Applicant: DAIMLER AG, Stuttgart (DE)

(72) Inventors: Gerhard Konrad, Ulm (DE); Benjamin Steinhauser, Leutkirch (DE)

(21) Appl. No.: 14/426,422

(22) PCT Filed: Aug. 16, 2013
(86) PCT No.: PCT/EP2013/002468

§ 371 Date: Mar. 6, 2015

(30) Foreign Application Priority Data
Sep. 25, 2012 (DE) 10 2012 018 873.0

(51) Int. Cl. H01M 8/04; H01M 8/10

(52) U.S. Cl. CPC H01M 8/04462; H01M 8/1018; H01M 2008/1095; H01M 2250/20

(57) ABSTRACT

A method for detecting a critical concentration of hydrogen in the exhaust gas of a fuel cell system (1), in which exhaust gas from an anode chamber (4) of a fuel cell (3) is post-combusted by means of a burner (17). The temperature of the combustion exhaust gases is detected, the temperature being compared to a predetermined limit value. In the comparison, a critical concentration of hydrogen is assumed if the temperature of the combustion exhaust gases is above the limit value.

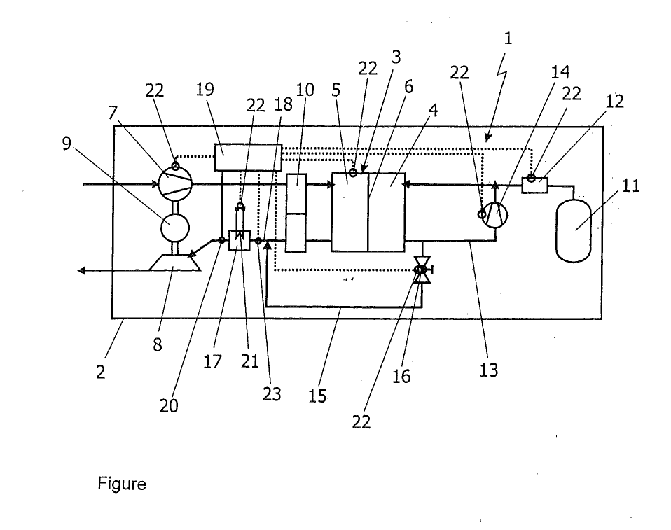

The invention relates to a method for detecting a critical concentration of hydrogen in the exhaust gas of a fuel cell system of the type defined in greater detail in the preamble of Claim 1. The invention further relates to the use of such a method.

In fuel cell systems, in particular in fuel cell systems which are used for vehicle drives, the risk of possible hydrogen emissions represents a significant safety hazard. For this reason, hydrogen sensors are typically situated in the exhaust gas of fuel cell systems, these hydrogen sensors being able to safely and reliably detect a possible escape of hydrogen via the exhaust gas, for example due to the failure of seals or membranes in the fuel cell, in order to trigger an appropriate warning message or an alarm, and shut down the fuel cell system if necessary.

A fuel cell system having an exhaust gas system is known from EP 1 990 858 B1, for example. A hydrogen sensor which is connected to a control unit is provided in the exhaust gas system. The sensor is designed as a catalytic sensor which has two different measuring sections for the electrical resistance, these measuring sections having a temperature-dependent design. A catalytically active material is situated in the region of one of the measuring sections, and in the presence of hydrogen is heated by a reaction of the hydrogen with atmospheric oxygen or residual oxygen in the exhaust air of the fuel cell. The presence of hydrogen may thus be detected due to a difference in resistance, which reflects a temperature difference, between the two measuring sections. An inherent disadvantage is that although hydrogen emissions can be detected, they cannot be prevented.

Alternative types of hydrogen sensors are likewise known from the general prior art, and are generally known and customary at approximately the same location in the fuel cell system.

The problem lies in the fact that hydrogen sensors are typically very complex and expensive to manufacture, and are often susceptible to malfunction, so that safety-critical situations may possibly occur due to a malfunction of the hydrogen sensor. These conventional systems are thus associated with significant disadvantages with regard to safety, as well as susceptibility to malfunction, and cost.

The object of the present invention is to provide a method for detecting a critical concentration of hydrogen in the exhaust gas of a fuel cell system, which avoids these disadvantages and allows a simple, economical, and very safe design.

In fuel cell systems, in particular in fuel cell systems in vehicles, it is frequently the case that residual gases containing hydrogen are post-combusted by means of a burner in order to safely and reliably prevent hydrogen emissions to the environment. The method according to the invention now makes use of this type of system by detecting the temperature of the combustion waste gases downstream from such a burner and comparing it to a predefined limit value. By use of a very simple, reliable, standard temperature sensor which is available at an economical cost, a critical concentration of hydrogen in the exhaust gas of the fuel cell system may be detected by monitoring the temperature of the combustion waste gases. If the temperature increases above a predefined limit value which is predefined statically or in particular dynamically as a function of the operating state of the fuel cell system, more fuel than expected must be present in the area of the combustion. This fuel in the fuel cell system is typically hydrogen, which enters into this area due to a possible leak. This hydrogen is detected via the increase in temperature above the predefined limit value, so that appropriate warning messages and/or a system shutdown may be triggered. Unlike the designs according to the prior art, the hydrogen is simultaneously consumed in the burner due to the combustion, so that, despite the hydrogen leak within the system which is the reason for the increased concentration, emissions of hydrogen to the environment may be safely and reliably avoided. The system is therefore very simple, safe, and reliable.

According to one advantageous refinement of the method according to the invention, it may also be provided that the exhaust gas from the anode chamber together with exhaust air from the cathode chamber of the fuel cell are post-combusted. This post-combustion of the exhaust gas from the anode chamber of the fuel cell together with the exhaust air from the cathode chamber of the fuel cell is particularly simple and efficient, since it is not necessary to convey an independent volume flow of oxygen for the combustion; instead, the residual oxygen in the volume flow which is conveyed through the fuel cell or its cathode chamber may be used. In addition, this embodiment of the method according to the invention offers a further safety advantage, since it is possible to detect not only increased concentrations of hydrogen in the exhaust gas from the anode chamber, but also increased concentrations of hydrogen in the exhaust gas from the cathode chamber. Possible leaks, for example in the membranes of the fuel cell, which is preferably designed as a PEM fuel cell, which may result in passage of hydrogen from the anode chamber into the cathode chamber, may thus likewise be safely and reliably detected. Here as well, the hydrogen which is discharged with the exhaust air from the fuel cell is on the one hand detected and on the other hand consumed by the combustion, so that in this case as well, hydrogen emissions to the environment are safely and reliably avoided.

In one advantageous refinement of the method according to the invention, a catalytic burner may be used as the burner. Such a catalytic burner is comparatively unsusceptible with regard to possible fluctuations in the supply of fuel, and, provided that it has a certain operating temperature, may ensure safe, reliable reaction of the hydrogen without ignition or the like necessarily occurring.

In one advantageous refinement of the method according to the invention, it may also be provided that in addition, the temperature of the exhaust gases from the anode chamber and optionally from the cathode chamber, or preferably a mixture thereof, is detected upstream from the burner, according to which a temperature difference between the temperature of the combustion waste gases and the temperature of the exhaust gases upstream from the burner is formed and compared to the predefined limit value. Such a measurement of two or optionally three temperatures, with a separate supply of the exhaust gases to the burner, allows a particularly simple and efficient determination of a temperature difference which exists over the burner. The measurement is largely independent of the operating behavior of the fuel cell system, which must be correspondingly included in the predefined limit value of the temperature for only one temperature measuring point downstream from the burner. This problem is avoided very easily and efficiently by the use of two temperature sensors, wherein the second temperature sensor, as a standard temperature sensor, may likewise be very easily situated directly upstream from the burner, preferably in a mixture of the two exhaust gases.

In one advantageous embodiment of the method according to the invention, in the case of electrical heating it may also be provided that a temperature increase which results from possible electrical heating of the burner is taken into account in specifying the limit value, the temperature of the combustion waste gases, and/or the temperature difference. Such electrical heating of the burner is quite common, in particular for catalytic burners, in order to quickly bring them to operating temperature, for example in a cold start situation or at very low ambient temperatures. In these cases, safe and reliable reaction of the hydrogen at the catalytic burner is thus made possible. However, due to the electrical heating, heat is introduced into the combustion waste gases, so that the temperature jump resulting from the electrical heating must be taken into account, either in the default value, or in the temperature of the combustion waste gases or the temperature difference, or both, depending on which value may be most easily changed by a suitable software operation.

Further variables which likewise may/should be taken into account here, in particular when only the temperature of the combustion waste gases is detected, may be, for example, the quantity and/or the temperature of the instantaneously metered starting materials, i.e., the instantaneously metered air and the instantaneously metered hydrogen, to the fuel. A time delay may also be taken into account, since the starting materials which are instantaneously metered do not leave the fuel cell as products and enter into the region of the burner until after a certain delay time.

Additionally or alternatively, a switching state of an exhaust valve and/or of a pressure retention valve in the anode exhaust gas may also be taken into account. In particular when anode recirculation is used, it is generally customary to discharge exhaust gas from the anode circuit via an exhaust valve, a so-called purge valve, for example intermittently or as a function of a nitrogen concentration in the anode circuit exhaust. This exhaust gas also always contains a certain quantity of residual hydrogen. Thus, in particular when only the temperature of the combustion waste gases is detected, it is crucial whether or not hydrogen-containing exhaust gas is passing from the anode circuit via the exhaust valve into the region of the burner at that moment, since this naturally will have an influence on the temperature. The knowledge of the switching state and of the volume flow of exhaust gas which accompanies this switching state should thus be taken into account, whereby the quantity of hydrogen which is typically contained in this exhaust gas from the anode circuit may be estimated, for example from a characteristic map or the like, with which the temperature increase thus caused may also be calculated. The same applies for a possible pressure retention valve during so-called near dead-end operation of the fuel cell or its anode chamber, in which hydrogen which could not be reacted in the anode chamber is discharged as anode exhaust gas, for example continuously or likewise discontinuously.

As a supplement or in addition, a quantity of product water which is discharged from the anode chamber with the exhaust gas, in particular for a discontinuous discharge, may correspondingly be taken into account. Since product water also occurs in addition to inert gases, in particular when anode recirculation is used, and since the product water is frequently discharged together with the gases from the system, the quantity of discharged product water may also possibly play a role, since it passes in liquid form into the region of the burner and vaporizes there, and has a corresponding influence on the temperature. This should also be taken into account in an optimized method according to the invention.

The preferred use of the method according to the invention lies in its application in a fuel cell system which provides electrical power, in particular electrical drive power, in a vehicle. In particular in these types of fuel cell systems in vehicles, which in each case have a comparatively small design and are intended for production in large quantities, it is crucial to implement a very reliable and economical approach in order to detect critical concentrations of hydrogen. This is possible via the method according to the invention. At the same time, due to the burner which is preferably designed as a catalytic burner, emission of hydrogen to the environment, even in the event of a leak, for example between the anode chamber and the cathode chamber of the fuel cell, is safely and reliably prevented. The system is therefore not only implemented easily and economically, but also allows a very high level of safety.

Further advantageous embodiments of the method according to the invention result from the remaining dependent claims, and become clear based on the exemplary embodiment which is described in greater detail below with reference to the FIGURE.

The single appended FIGURE shows a fuel cell system in a schematically indicated vehicle which is designed for implementing the method according to the invention.

A fuel cell system 1 in a schematic depiction is apparent from the illustration in the FIGURE. The fuel cell system is intended for installation in a vehicle 2, in particular for providing electrical drive power for the vehicle 2. The core of the fuel cell system 1 is a fuel cell 3 which comprises an anode chamber 4 and a cathode chamber 5. In the embodiment of the fuel cell 3 as a PEM fuel cell stack illustrated here, the anode chambers and cathode chambers are separated from one another in each case by proton exchange membranes 6. Only one of the anode chambers 4, one of the cathode chambers 5, and one of the membranes 6 are indicated in the illustration as an example. Air as the oxygen supplier is fed to the cathode chamber 5 of the fuel cell 3 via an air conveying device 7. The exhaust air from the cathode chamber 5 passes through a turbine 8 in which it is expanded for recovering residual energy, and is released to the environment. The turbine 8 and the air conveying device 7 are situated on the same shaft, on which an electric machine 9 is also situated. This design is also referred to as an electric turbocharger (ETC). The energy recovered in the turbine 8 is used directly for driving the air conveying device 7, and typically required additional power is provided via the electric machine 9. If it occurs in special situations that the power present in the turbine 8 is greater than the amount of power required at that moment by the air conveying device 7, electrical energy may also be obtained via the electric machine 9 in generator mode, and may then be supplied for other uses, for example, or temporarily stored in a battery.

In addition, a gas/gas humidifier 10, known per se, is situated in the feed air stream between the air conveying device 7 and the cathode chamber 5, and in the exhaust air stream between the cathode chamber 7 [sic; 5] and the turbine 8. This humidifier 10 may be designed, for example, strictly as a humidifier or as a combination of a humidifier and a charge air cooler. The humidifier is used to humidify and/or cool the feed air upstream from the cathode chamber, and for this purpose utilizes the moist, comparatively cool exhaust air from the cathode chamber 5. This design is known per se, and therefore is not described in greater detail here. However, it is noted that in principle it is also possible to provide a charge air cooler and a. humidifier in the feed air stream independently of one another.

Hydrogen as fuel is supplied to the anode chamber 4 of the fuel cell 3 from a pressurized gas store 11. The hydrogen passes into the anode chamber 4 via a pressure control and metering valve 12. Exhaust gas from the anode chamber 4 is recycled via a recirculation line 13 and a recirculation conveying device 14, and together with the fresh hydrogen flows once again into the anode chamber 4 of the fuel cell 3. This design is also referred to as anode recirculation. In such anode recirculation, water and inert gases which diffuse through the proton exchange membranes 6 from the cathode chamber 5 into the anode chamber 4 accumulate over time. Since the volume in the anode recirculation is constant, the concentration of hydrogen thus inevitably drops, so that the performance of the fuel cell 3 decreases. For this reason, it is customary to discharge gases and optionally water from the anode recirculation, for example intermittently or as a function of a material concentration, such as the nitrogen concentration in the recirculation line 13. For this purpose, a discharge line 15 having an exhaust valve 16 is illustrated in the FIGURE. In addition to inert gases, in particular nitrogen, the discharged gas also always contains a residual quantity of hydrogen, which is unavoidable in the described design. To prevent hydrogen emissions to the environment and in order to not waste the energy contained in the hydrogen, in the exemplary embodiment illustrated here the discharge line 15 opens into an exhaust air line 18 upstream from a catalytic burner 17 in the flow direction of the exhaust air from the cathode chamber 5. The exhaust air from the cathode chamber 5 and the exhaust gas from the anode chamber 4 or the anode recirculation then flow together into the catalytic burner 17 and are catalytically reacted therein, wherein the residual hydrogen in the exhaust gas from the anode chamber 4 appropriately reacts with the residual oxygen in the exhaust gas from the cathode chamber 5. The exhaust gas is thus heated and the contained hydrogen is thermally reacted, so that hydrogen emissions to the environment may be safely and reliably avoided. The heated exhaust gas then flows through the turbine 8 and is expanded in the turbine 8. At least a portion of the energy introduced into the combustion waste gases of the catalytic burner 17 due to the heating of the exhaust gas may thus be recovered in the region of the turbine 8.

The fuel cell system 1 in the vehicle 2 also has at least one control unit 19 which is in communication connection at least with a temperature sensor 20, the temperature sensor 20 being designed for determining the temperature of the combustion waste gases of the catalytic burner 17 and preferably being situated directly downstream from the catalytic burner 17 in the flow direction.

In order for the catalytic burner 17 to safely and reliably start and to dependably react the hydrogen, even at harsh ambient temperatures and in particular during a cold start of the fuel cell system 1 at very low ambient temperatures, for example ambient temperatures below the freezing point, an electric heater 21 may also be provided in the catalytic burner 17 in order to safely and reliably heat same to operating temperature if necessary.

This design, with the exception of the temperature sensor 20, is in principle known from the general prior art. Due to the additional temperature sensor 20, which is preferably placed in the combustion waste gases as a simple, inexpensive temperature sensor, the temperature of the combustion waste gases may now be monitored. In the exemplary embodiment illustrated here, this temperature is ultimately correlated with the quantity and temperature of the exhaust air, and with the quantity, temperature, and hydrogen content of the exhaust gases from the anode chamber 4. If the exhaust gases are discontinuously supplied via the exhaust valve 16, correspondingly fluctuating temperature values result. If a diaphragm is used as an alternative to the exhaust valve 16, this results in much more constant temperature values.

The temperature values are always a function of the operating parameters of the fuel cell system 1. To detect these temperature values, numerous optional sensors 22 are depicted in the illustration in the FIGURE which are situated, for example, in the area of the air conveying device 7, the electric heater 21, the fuel cell 3 itself, the recirculation conveying device 14, the pressure control and metering valve 12, or also for detecting the state of the exhaust valve 16 in this area. All of these sensors supply the control unit 19, if desired, with appropriate information which ultimately allows a conclusion concerning the expected temperature of the combustion waste gases. If the temperature of the combustion waste gases in the area of the temperature sensor 20 is less than or equal to such a predefined expected temperature value, the fuel cell system 1 is functioning correctly. If the temperature rises above such a predefined value, this must have an appropriate reason. Since only hydrogen from the pressurized gas store 11 is present as fuel in the fuel cell system 1, the reason must ultimately be that more hydrogen is entering into the region of the catalytic burner 17 than expected, for example via leaks or the like. Thus, an undesirably high concentration of hydrogen is present, which may be a clear indication of a problem, for example in the area of the exhaust valve 16 or in particular in the area of the fuel cell 3 itself, such as a leak due to a torn proton exchange membrane 6 or the like. A safety warning, or, if necessary, an emergency shutdown of the fuel cell system 1, may then be triggered via the control unit 19. At the same time, the discharged hydrogen is completely reacted in the catalytic burner 17, so that emission of hydrogen to the environment may be safely and reliably prevented.

In addition or as an alternative to the plurality of the mentioned sensors 22, it is now also possible to arrange a very simple additional temperature sensor 23 in the area of the exhaust air line 18, preferably after the latter has been joined to the discharge line 15. The temperature upstream from the catalytic burner 17, in particular ideally directly upstream from the catalytic burner 17, may now be detected via this temperature sensor 23. A temperature difference between the temperature sensors 23 and 20 thus allows a determination of the heat introduced into the catalytic burner 17, which is a direct function of the concentration of hydrogen present in the region of the catalytic burner 17, so that, largely independently of other operating parameters, the temperature difference may be used to very easily and efficiently draw conclusions concerning the hydrogen concentration. If the hydrogen concentration exceeds a critical value, the temperature difference then exceeds a predefined limit value of the temperature difference, and an appropriate warning message and/or a shutdown of the fuel cell system 1 may be triggered.

If the electric heater 21 is now connected in the region of the catalytic burner 17, this naturally also has a corresponding influence on the temperature 20, and, unlike the case for most of the other operating parameters, naturally also has an influence on the temperature difference between the temperature sensors 23 and 20. In the case of the connected electric heater 21, it is thus necessary to detect, for example, the electrical heating power via the sensor 22 in the area of the electric heater 21, so that conclusions may be drawn concerning the heat introduced into the catalytic burner 17, and this information may be appropriately taken into account in calculating the temperature difference between the temperature sensors 23 and 20. Thus, despite the electric heater 21, a conclusion concerning a possibly critical concentration of hydrogen in the fuel cell system 1 may then be easily and reliably drawn via a temperature measurement at least downstream from, but preferably upstream and downstream from, the catalytic burner 17.

1.-10. (canceled)

11. A method for detecting a critical concentration of hydrogen in the exhaust gas of a fuel cell system (1), comprising:
post-combusting exhaust gas from an anode chamber (4) of a fuel cell (3) by means of a burner (17),
detecting the temperature of the combustion exhaust gases,
comparing the temperature of the combustion exhaust gases to a predetermined limit value, and
in the comparison, assuming a critical concentration of hydrogen if the temperature of the combustion exhaust gases is above the limit value,
wherein the exhaust gas from the anode chamber (4) together with exhaust air from the cathode chamber (5) of the fuel cell (3) is post-combusted, and wherein, in addition, the temperature of the exhaust gases from the anode chamber (4) and optionally from the cathode chamber (5), or a mixture thereof, is detected upstream from the burner (17), according to which a temperature difference between the temperature of the combustion waste gases and the temperature of the exhaust gases upstream from the burner (17) is formed and compared to the predefined limit value.

12. The method according to claim 11, wherein a catalytic burner (17) is used as the burner.

13. The method according to claim 11, wherein a temperature increase which results from possible electrical heating (21) of the burner (17) is taken into account in specifying the limit value, the temperature of the combustion waste gases, and/or the temperature difference.

14. The method according to claim 11, wherein the quantity and/or the temperature of the starting materials which are metered to the fuel cell (3), instantaneously or offset by a lead time, is/are taken into account in specifying the limit value, the temperature of the combustion waste gases, and/or the temperature difference.

15. The method according to claim 11, wherein a switching state of an exhaust valve (16) and/or of a pressure retention valve in the exhaust gas of the anode chamber (4) is taken into account in specifying the limit value, the temperature of the combustion waste gases, and/or the temperature difference.

16. The method according to claim 11, wherein a quantity of product water which is discharged from the anode chamber (4) with the exhaust gas is taken into account in specifying the limit value, the temperature of the combustion waste gases, and/or the temperature difference.

17. The method according to claim 11, wherein a quantity of product water which is discharged from the anode chamber (4) with the exhaust gas for a discontinuous discharge is taken into account in specifying the limit value, the temperature of the combustion waste gases, and/or the temperature difference.

18. The method according to claim 11, wherein a warning message is output and/or the fuel cell system (1) is shut down if there is a critical concentration of hydrogen.

19. A method according to claim 11, wherein the fuel cell (3) is used in a fuel cell system (1) which provides electrical power in a vehicle (2).

20. A method according to claim 11, wherein the fuel cell (3) is used in a fuel cell system (1) which provides electrical drive power in a vehicle (2).
